(19) United States
(12) Patent Application Publication
(10) Pub. No.: US 2024/0151031 A1
(43) Pub. Date: May 9, 2024

(54) INSULATING AND CONSTRUCTION ELEMENTS BASED ON RENEWABLE MATERIALS

(71) Applicant: Ewald Dörken AG, Herdecke (DE)

(72) Inventors: Henning Sand, Dortmund (DE); Michael Wolf, Wuppertal (DE); Uwe Kaiser, Herdecke (DE); Filippo Palermo, Dortmund (DE); Timo Pleuser, Wermelskirchen (DE)

(73) Assignee: Ewald Dörken AG, Herdecke (DE)

(21) Appl. No.: 18/549,531

(22) PCT Filed: Mar. 9, 2022
(86) PCT No.: PCT/EP2022/056024

§ 371 Date: Sep. 7, 2023

(30) Foreign Application Priority Data
Mar. 10, 2021 (DE) 10 2021 105 829.5

(51) Int. Cl. E04C 2/284; B32B 3/30; B32B 5/20; E04C 2/52; E04F 15/20

(52) U.S. Cl. CPC E04C 2/284; B32B 3/30; B32B 5/20; E04C 2/525; E04F 15/206; B32B 2307/102; B32B 2307/304; B32B 2307/3065; B32B 2307/72; B32B 2307/73; B32B 2607/00

(57) ABSTRACT

A composite element for use as an insulating and/or construction means, where at least one layer is configured in the form of a foam layer, and where the foam layer comprises a foam material comprising a natural, renewable raw material; methods of using composite elements for thermal and/or acoustic insulation, including of buildings and/or roofs, and in the installation of heating and/or utility systems, including in floors and/or walls of buildings; an in-situ foam as well as a particulate foam material in loose filling for use as an insulating means; and an installation panel.

The present application is the U.S. national stage application of international application PCT/EP2022/056024 filed Mar. 9, 2022, which international application was published on Sep. 15, 2022, as International Publication WO 2022/189500. The international application claims priority to German Patent Application No. 10 2021 105 829 filed Mar. 10, 2021. The international application and the German application are hereby incorporated herein by reference in their entireties.

### FIELD

The present invention relates to the technical field of construction, in particular to the thermal insulation or thermal supply of buildings.

### SUMMARY

In particular, the present invention relates to a composite element for use as an insulating and/or construction means.

Furthermore, the present invention relates to uses of a composite element, in particular according to the invention, for thermal and/or acoustic insulation, in particular of buildings and/or roofs, and for the installation of heating and/or supply systems, in particular in floors and/or walls of buildings.

Furthermore, the present invention relates to an underfloor heating element, as well as to a thermal insulation for use in thermally insulating walls and/or roofs of buildings, and to an footfall sound insulation and/or acoustic absorber for use in sound insulating walls and/or floors of buildings, each obtained from a composite element.

Furthermore, the present invention relates to an in-situ foam and a particulate foam material in loose bulk for use as an insulating material, in particular as a blow-in insulation, preferably for thermal and/or acoustic insulation.

Finally, the present invention relates to an installation panel, in particular for use in a floor assembly or for use as an insulation panel.

### BRIEF DESCRIPTION OF DRAWINGS

The present disclosure is described with reference to the following drawings.

It shows the figure representations according to:

FIG. 1 is a cross-sectional view of a composite element according to the invention and an enlarged section of the foam layer thereof;

FIG. 2 is a perspective representation of a composite element according to the invention, comprising a foam layer and a functional and/or reinforcing layer in the form of a functional film;

FIG. 3 is a perspective view of a composite element according to the invention, comprising a foam layer arranged between two functional and/or reinforcing layers in the form of reinforcing sheets;

FIG. 4 is a perspective representation of a composite element according to the invention formed as a nubbed panel with round nubs;

FIG. 5 is a top view representation of a composite element according to the invention formed as a nubbed panel with round nubs;

FIG. 6 is a side view of a composite element according to the invention represented as a nubbed panel with round nubs;

FIG. 7 is a perspective representation of a composite element according to the invention formed as a nubbed panel with angular nubs;

FIG. 8 is a side view representation of a composite element according to the invention formed as an underfloor heating element in the form of a nubbed panel with angular nubs;

FIG. 9 is a perspective representation of a composite thermal insulation system comprising a composite element according to the invention;

FIG. 10 is a perspective representation of a wall insulation based on an in-situ foam according to the invention;

FIG. 11 is a perspective representation of a wall insulation based on an insulation according to the invention in the form of a particulate foam material;

FIG. 12 is a side view representation of a composite element according to the invention formed as an installation panel with recesses;

FIG. 13 is a perspective view of a composite element according to the invention represented as an installation panel with recesses;

FIG. 14 is a side view representation of a composite element according to the invention formed as an underfloor heating element in the form of an installation panel with recesses;

FIG. 15 is a side view representation of a composite element according to the invention in the form of an underfloor heating element in the form of an installation panel with recesses and a heat-conducting layer; and

FIG. 16 is a further side view representation of a composite element according to the invention in the form of an underfloor heating element in the form of an installation panel with recesses and a heat-conducting layer.

### DETAILED DISCLOSURE

In September 2015, goals for more sustainable development were adopted by the heads of state and government of the member states of the United Nations at the UN Sustainability Summit in New York. One aspect of these goals is the sustainable design of economic production and consumption and the protection of the environment. Sustainable development and design encompasses ecological, economic and social aspects on an equal footing, as well as the goal of leaving an intact environment and equal opportunities for life to future generations.

The construction industry traditionally represents a resource-intensive branch of industry, especially with regard to the demand for and use of material and monetary resources. Likewise, long-term measures are usually pursued or performed in the construction sector, the results of which shape the surrounding environment, sometimes for several decades, sometimes for centuries.

Based on this, there are therefore in particular also in the building industry or building sector increasing efforts and initiatives to look for and develop sustainable or more sustainable solutions and applications, which make it possible to realize the aforementioned, overriding goal of an overall sustainable development, among other things, with regard to the planning, construction, inventory management and operation of buildings.

In this context, the development and use of alternatives to known building materials, which can be considered positive from an ecological point of view, represent an essential aspect, for which, among other things, a generally optimized use of building materials and products, a minimization of energy and water consumption, in particular also in the context of the production of building materials and products, as well as an overall minimization of environmental pollution on a local and global level are aimed for.

At the same time, economic aspects must be taken into account in the context of sustainable building projects, such as in particular the follow-up and utilization costs incurred in connection with a newly constructed building as well as a refurbished or modernized existing building, over and above the acquisition or construction costs. In particular, the energy efficiency of buildings is relevant here. The building sector represents—at least in Germany—one of the largest energy consumers, whereby energy is primarily required for temperature regulation, i.e. for heating or possibly also cooling buildings.

An important contribution to increasing and fusing the energy efficiency of a building can be made, for example, by installing a suitable thermal insulation system. Thermal insulation is mainly provided by so-called exterior or façade insulation, i.e. the outside of the building is usually fitted with thermal insulation. However, in particular in the case of existing buildings, interior insulation can also be used, e.g. for the subsequent insulation of roofs or attics.

Thermal insulation systems made of petrochemical-based materials, such as foams made of polyurethane or expanded polystyrene, are frequently used for this purpose. While such thermal insulation systems have excellent insulating properties under ideal conditions, they have the disadvantage of being combustible and usable only at limited temperatures.

Furthermore, these insulation systems configure a vapor barrier so that moisture from the masonry cannot be released into the environment, which can subsequently lead to the production of mold and algae on and in the building facade. In terms of sustainability, insulation made of polyurethane or polystyrene is also disadvantageous in that the materials are produced from non-renewable raw materials in an energy-intensive way and are not particularly environmentally friendly to dispose of.

Another option is the use of mineral-based insulation materials or systems. These are usually dimensionally stable, open to diffusion and non-combustible. However, compared with polymeric insulating materials, they have the disadvantage that they comprise a high density, so that insulating systems with a high dead weight are obtainable. These systems also lag behind plastic-based systems in terms of thermal insulation properties. In addition, mineral-based materials, like petrochemical-based materials, are fossil-based raw materials that are non-renewable. Finally, the producing of mineral-based insulation materials, such as rock wool and glass wool, takes place in furnaces at temperatures of approximately 1500° C. Considering the CO2 balance of the producing process in addition to the above mentioned disadvantages, these materials are therefore not a sustainable option.

Alternatively, insulation systems based on mineral wool or natural organic fibers, such as wood, cork, hemp and reed fibers, are used to a lesser extent. However, these systems often lack the necessary mechanical stability and structural integrity, i.e. they are not dimensionally stable but have to be specially reinforced or supported. Wood fiber insulation boards and soft wood fiber boards, for example, cannot withstand compressive loads adequately, in particular at specific points. There is also still potential for development with regard to the insulating effect of the materials mentioned. On the other hand, the fact that materials from natural and renewable raw material sources are used is positive from an economic and ecological point of view.

In particular, an integrated view of the sustainability of existing thermal insulation systems shows that there is still a great need for development in terms of thermal insulation that achieves a high insulating effect and can be produced as sustainably as possible. Of central importance in this context is the choice of materials used in the respective insulation.

Wood and woody plants are among the oldest raw materials used, in particular for construction. Accordingly, there are a large number of concepts and products that address uses in the construction sector, such as the softwood fiberboard already mentioned.

In the field of insulation materials, however, and in particular with regard to practical, efficient and easy-to-use insulation applications, there is still a considerable need for products that provide good insulation performance and are durable and resilient, as well as being safe to use with regard to health aspects. For example, many wood-based products still contain added chemicals, such as binding agents, which can evaporate and release harmful substances such as formaldehyde.

Accordingly, there has been no lack of attempts in the prior art to develop solutions that overcome these disadvantages.

For example, DE 10 2010 008 525 A1 relates to lignocellulose-containing moldings that are free of binding agents and are produced using an enzymatic wet process and enzymatic dry process. In these methods, special mediators or catalysts as well as phenol oxidizing enzymes are used to produce the bond in the molded article. However, enzymatic-based methods are generally very complex to carry out and prone to failure. Also, the scalability of enzymatic methods is often limited, making large-scale use unattractive.

WO2002/055722 also relates to a method for producing a porous material based on wood. Here, wood chips are subjected to a fermentation process, from which a moldable mass is obtained that is subsequently dried using radio wave radiation. However, fermentation processes usually take a certain amount of time, so that the proposed method is quite lengthy overall and also quite costly in terms of drying using microwave radiation.

Against this background, there is a continuing need for innovative materials or components that are suitable for use in the construction industry and in particular for the application-friendly and efficient insulation of buildings, and which can also be regarded as positive in terms of sustainability.

The present invention is therefore based on the objective of providing an insulating and/or structural or building element, wherein the problems and disadvantages described above in connection with the prior art are to be at least largely avoided or at least mitigated.

In particular, it is an objective of the present invention to provide an insulating and/or structural element which can be produced sustainably and is also characterized by good application properties, i.e. reliable insulating properties and efficient manageability.

The objective set out above is solved according to the present invention by a composite element according to claim 1; advantageous further embodiments and configurations of the method according to the present invention are the subject-matter of the related dependent claims.

A further subject-matter of the present invention—according to a second aspect of the present invention—is a use of a composite element, in particular according to the invention, for thermal and/or acoustic insulation, in particular of buildings and/or roofs, preferably of floors, walls and roofs, according to claim 13.

Again, another subject-matter of the present invention—according to a third aspect of the present invention—is a use of a composite element, in particular according to the present invention, in the installation of heating and/or utility systems, in particular in floors and/or walls of buildings, preferably of underfloor heating systems, according to claim 14.

Furthermore, subject-matter of the present invention—according to a fourth aspect of the present invention—is an underfloor heating element according to claim 15.

Again, further subject-matter of the present invention—according to a fifth aspect of the present invention—is a thermal insulation, obtainable from composite elements according to the present invention, for use in the thermal insulation of walls and/or roofs of buildings according to claim 16.

Further subject-matter of the present invention—according to a sixth aspect of the present invention—is an footfall sound insulation and/or an acoustic absorber, obtainable from a composite element according to the invention, for use in the sound insulation of walls and/or floors of buildings according to claim 17.

Further subject-matter of the present invention—according to a seventh aspect of the present invention—is an in-situ foam for use as an insulating and/or construction means, in particular for thermal and/or acoustic insulation according to claim 18.

Further subject-matter of the present invention—according to an eighth aspect of the present invention—is a particulate foam material in loose bulk, in particular for use as an insulating agent, preferably in the form of a blow-in fill, for thermal and/or acoustic insulation, according to claim 19.

Finally, the subject-matter of the present invention—according to a ninth aspect of the present invention—is installation panel, in particular for use in a floor structure, according to claim 20; advantageous further embodiments and configurations of the installation panel according to the present invention are the subject-matter of related dependent claims.

It goes without saying that special features, characteristics, embodiments and configurations as well as advantages or the like which are set forth below—for the purpose of avoiding unnecessary repetition—with respect to only one aspect of the invention apply, of course, according to the remaining aspects of the invention without the need for express mention.

In addition, it applies that all value or parameter data or the like mentioned in the following can in principle be determined or determined with standardized or explicitly stated determination methods or with determination methods which are familiar to the person skilled in the art in this field.

Furthermore, it goes without saying that all weight- or quantity-related percentages are selected by the person skilled in the art in such a way that the total results in 100%.

With this proviso stated, the present invention will be described in more detail below.

The subject-matter of the present invention—according to a first aspect of the present invention—is a composite element for use as an insulating and/or construction means, in particular for heat and/or sound insulation and/or for the installation of heating and/or supply systems, comprising an at least two-layer structure, wherein at least one layer of the composite element is configured in the form of a foam layer, and wherein the foam layer comprises a foam material, wherein the foam material comprises a natural, renewable raw material.

For, as the applicant has surprisingly found out, the composite element according to the invention is distinguished from comparable composite elements from the prior art, i.e. composite elements which comprise a substantial proportion of renewable raw materials but which are not present in particular in the form of a foam, by a significantly increased strength, in particular with respect to compressive load, and also by improved thermal insulation properties and sound-insulating properties. In this context, it is particularly advantageous that composite elements according to the invention retain their insulating properties even if the composite element is exposed to increased amounts of moisture.

Usually, insulating materials based on natural raw materials in particular lose their insulating properties if they are exposed to high amounts of moisture, for example in the form of water vapor and liquid water in particular. The loss of function is not reversible, so that according to this the insulation has to be exchanged and replaced at great expense. This problem is particularly pronounced in the case of conventional softwood fiberboards, which, as insulating elements, are irreversibly damaged and fail from a moisture absorption of 30%, based on the softwood fiber content of the boards.

Composite elements according to the invention do not exhibit this disadvantageous behavior and retain their insulating effect even in the presence or after absorption of moisture. Furthermore, it is also possible for the composite element according to the invention to regenerate completely after absorbing increased or particularly high quantities of water or water vapor, for example as a result of water penetration or water damage, without there being any need to fear any subsequent loss of performance. In addition, the composite element according to the invention, in contrast to comparable materials based on, for example, softwood fiber material, is characterized by particularly high dimensional stability and comprises a swelling of only less than 1% in the presence of moisture, in particular already without hydrophobing.

The improved or increased mechanical and physical parameters of the composite element according to the invention can be attributed in particular to the foam layer contained in the composite element. Compared to comparable fiber or wool layers based on renewable raw materials, the foam layer specifically used or provided in the context of the present invention is characterized by high mechanical strength and high structural integrity. These properties are based in particular on the stable and durable foam structure of the foam layer or of the foam material comprised therein, which is based on a natural, renewable raw material.

The foam material used according to the invention achieves these advantageous properties in particular on the basis of the high degree of crosslinking of the foam material in combination with advantageous gas retention properties, which result in a preferably open-pored, highly stable as well as durable foam structure.

Furthermore, on the basis of this advantageous structure or composition of the foam layer provided according to the invention, excellent insulating properties are achieved, which have not been accessible so far with comparable or alternative insulating materials based on renewable raw materials. In particular, the foam material is characterized by an advantageous ratio of porosity to material quantity or mass, which is reflected in densities and weights per unit area that can be rated as consistently positive. Thus, on the basis of the foam material provided for the foam layer according to the invention, a weight-optimized composite element can also be obtained overall, which is accordingly characterized by a balanced ratio of its own weight to the insulating performance achieved. In particular, in the field of insulation of roofs of buildings, this aspect is of crucial importance for both above-rafter and between-rafter or below-rafter insulation, in particular since any additional weight must be compensated by building walls and foundations.

With the present invention, therefore, composite elements can now be made available for the first time which comprise a foam layer whose foam material comprises a natural, renewable raw material, and wherein the composite elements provided are preferably reliably weather-resistant and in particular moisture-resistant, highly mechanically resilient as well as effective and, not least, weight-optimized with respect to a variety of applications on as well as in a building.

Furthermore, composite elements according to the invention are characterized by in particular excellent composite adhesion and correspondingly high durability and resistance. In this way, on the basis of the present invention, the range of applications in particular of the foam material preferred according to the invention can be significantly expanded on the basis of the advantageous integration thereof in composite elements according to the invention, and the present invention thus likewise provides diverse, user-friendly and easy and efficient to handle construction or insulation elements on the basis of the composite elements according to the invention.

In this context, the composite elements according to the invention are excellently suitable—in particular depending on the specific design or configuration—for use in all types of insulation, i.e. for both exterior and interior insulation of buildings as well as for insulation of roofs. In addition, composite elements according to the invention can also be configured as sound-insulating structural elements that can be used, for example, for footfall sound insulation in a floor structure. Composite elements according to the invention can also be used in the form of prefabricated building components or walls as part of the rapid and efficient construction and expansion of buildings. In this respect, composite elements according to the invention are advantageously suitable for a wide range of applications and can accordingly be designed and configured in a highly variable manner.

In addition to these application-oriented advantages, a significant further advantage of the present invention remains that the composite elements according to the invention, which can be used in a variety of flexible ways, can be regarded to a high degree or to a large extent as a sustainable solution for the building sector, in particular in comparison with standardly used insulating or construction elements.

In the context of the present invention, a natural or, in particular, renewable raw material is understood to be organic raw materials that originate from agricultural and forestry production and are used specifically for further applications outside the food and feed sector. Also understood as raw materials in the context of the present invention are valuable substances or production by-products and/or substances from reusable or recyclable sources, which are originally based on a renewable raw material.

Furthermore, a layer in the context of the present invention is to be understood as an essentially two-dimensional sheet-like structure, i.e. such sheet-like structures have two decisive surfaces or in particular surfaces. The layer thickness or the corresponding side edges or surfaces of the layer are significantly smaller in size according to the extent of the (upper) surfaces.

In the context of the present invention, particularly good results are now obtained if the natural, renewable raw material is a plant-based raw material, in particular based on lignified and/or woody plants, preferably wood. Thus, preferentially, the natural, renewable, in particular plant-based, raw material comprises lignin- and/or lignocellulose-based raw materials or, in particular, plants.

Advantageously, almost all types of wood or components of woody plants, i.e. lignin- and/or lignocellulose-based plants, can be used in the context of the present invention. Accordingly, the natural, renewable, in particular plant-based, raw material may preferably be selected approximately from the group consisting of hardwood, coniferous wood, bark, root material, thinning wood, woody annual plants and mixtures thereof. Likewise, it is also possible that the natural, renewable, in particular plant-based, raw material is obtainable from sawmill by-products, waste wood, wood-containing waste products and/or recyclable or recycled wood-containing products.

Accordingly, a particular advantage of the present invention is that the foam layer can be obtainable from a variety of potential starting materials or raw material sources. In particular, with respect to the starting materials or raw material sources for the foam layer of the composite element according to the present invention, it is of primary importance that these are obtained from raw materials or sources based on lignified and/or woody plants

Preferentially, the natural, renewable, in particular plant-based, raw material thereby comprises a particulate, in particular fibrous, form and/or structure. Furthermore, it is even more preferred in the context of the present invention if the natural, renewable, in particular plant-based, raw material is present in the form of particles, in particular fibers, preferably containing lignocellulose.

Lignocellulose forms the cell wall of lignified or woody plants and serves as their structural framework. Hemicelluloses and especially cellulose initially form a framework into which lignin is subsequently incorporated during the lignification process, ultimately resulting in lignocellulose.

In the context of the present invention, therefore, a particulate material based on a natural, renewable, in particular plant-based, raw material, preferably based on wood or components of woody plants, is preferably comprised for the foam material of the foam layer. It is even more preferred if the wood or components of coniferous woods are used, in particular wherein fresh coniferous woods are even more preferably used. This particular preference for, in particular fresh, softwoods can be attributed to the comparatively high lignin content, which has a positive effect on the foam material of the foam layer.

Here, as previously stated, the raw material source can vary over a wide range. In accordance with a further advantage of the present invention, this aspect allows a particularly variable or flexible design of the manufacturing process of the composite element according to the invention or, in particular, of the foam layer comprised by the composite element

In particular, the product according to the present invention is designed to be so flexible in its producing process that it depends little or hardly at all on a particular raw material source or quality, which permits both cost-effective producing of composite elements according to the present invention and producing that can be adapted depending on the raw material supply. In particular, in the context of the present invention, essentially all materials which comprise a lignin or a lignocellulose content, such as, for example—in addition to the aforementioned raw material sources—also wood wool, wood fibers, jute, flax and plant-based waste from the agricultural industry, among others, can in principle be considered as suitable raw materials.

With regard to the nature of the renewable raw material, it is preferred, as already mentioned, if it comprises a particulate, in particular fibrous, form. It has been well proven in particular if the particles or, in particular, fibers of the raw material comprise particle sizes and/or fiber lengths in a range from 100 μm to 50 mm, in particular 200 μm to 10 mm, preferably 250 inn to 5 mm, preferably 300 inn to 2.5 mm, based on the renewable raw material in its initial state.

Such small particles or, in particular, short fibers of the natural, renewable raw material can be obtainable, for example, from refining processes or grinding processes. It has been found to be advantageous to carry out two refining processes, in particular wherein first a comparatively coarser and then a finer refining stage is selected. Within the framework of this procedure, there is therefore in particular also the possibility of setting the particle size or fiber length specifically and according to the application requirement or purpose, for which in particular the geometry of the grinding tools used, the grinding plate spacing and/or the number of grinding cycles are decisive.

An advantage of the fibers with small fiber sizes preferably used according to the invention is that the material can be returned to the process without any problems. In addition, no adhesive is required for producing the foam material in the context of the present invention, so that the reusability of the foam material is again significantly improved. Offcuts or production residues can thus be reused, in contrast to softwood fiberboards (HWF boards), where any production residues must be disposed of. Consequently, the foam material used according to the invention is significantly more sustainable and resource-saving than materials used to date.

Preferably, fiber suspensions that are in particular highly viscous and serve as the starting composition for the foam material used according to the invention are obtained in the course of the refining or grinding processes.

Properties of the foam material, such as its density or strength, can be set variably if fiber suspensions with raw material fibers or particles of different lengths or sizes are mixed. The viscosity of the suspension can also be set by decanting excess liquid, in particular in the form of water, for example, or by adding liquid or a solvent, in particular water, to the ground mass if a lower-viscosity suspension is desired. The suspensions used are characterized in particular by good gas retention properties, which is especially advantageous for foam formation.

Now, with regard to the composition of the foam material of the foam layer of the composite element according to the invention, this can vary or be varied depending on the application or intended use of the composite element. In accordance with the invention, it is preferred if the natural, renewable raw material has a proportion of more than 84 wt. %, in particular 89 wt. %, preferably 92 wt. %, preferably 94 wt. %, very preferably 95 wt. %, of the total composition of the foam material.

Likewise, it has been well proven in the context of the present invention if the natural, renewable raw material has a proportion in the foam material in a range from 84 to 100 wt. %, in particular 89 to 100 wt. %, preferably 92 to 99.5 wt. %, preferably 94 to 99 wt. %, very preferably 95 to 98.5 wt. %, based on the total composition of the foam.

It is thus preferably provided in the context of the present invention that the foam material of the foam layer is formed quite predominantly or, in particular, almost completely from renewable raw materials, which is to be regarded as particularly positive, in particular from the point of view of sustainability.

It should also be mentioned as advantageous in this context that within the scope of the present invention not only raw materials, in particular wood or woody plants, from agricultural or forestry production can be used, but also such materials can serve as starting materials or raw materials which, for example, are obtained as by-products or waste products in recycling processes or further production processes.

The foam material of the foam layer of composite elements according to the invention can therefore also be obtainable, for example, in particular at least substantially exclusively from production waste or recycling sources.

In this sense, within the scope of the present invention, it is thus also possible to further process materials based on natural raw materials that have already been processed in a value-adding manner. This advantageously allows a conservation of natural resources as well as a useful and valuable utilization of process by-products or alleged wastes. Thus, within the scope of the present invention, overall positive influence can be exerted on value-added cycles of renewable raw materials and thus a product can be provided which can be evaluated as environmentally friendly as well as sustainable.

However, depending on the intended application or use, it may be appropriate within the scope of the present invention to modify the properties of the foam material. In this context, it may prove advantageous if the foam material comprises one or more additives. Preferentially, the one or more additives are thereby selected from the group of hydrophobing agents, flame retardants, glow retardants, fungicides, oxidizing agents, blowing agents, thickening agents, crosslinking agents, gelling agents, emulsifiers, pH regulators, plasticizers, binding agents, inorganic and/or mineral fillers and/or mixtures thereof.

Suitable hydrophobing agents include synthetic or natural oils, kerosenes, waxes or organosilicon compounds. Advantageously, the addition of hydrophobing agents allows the ability or tendency of the foam material to absorb water to be reduced, which in particular has a positive effect on the long-term durability of the foam and thus of the composite element according to the invention. In the context of the present invention, kerosenes and waxes are preferably used as hydrophobing agents, since they represent environmentally compatible materials and contribute to excellent ecological properties of the obtainable products.

Preferentially, perlite, vermiculite and/or exfoliated graphite are used as flame retardants or glow retardants. In particular, if the composite element according to the invention is to be used for insulating facades or for cladding exterior walls of buildings, the use of the aforementioned flame retardants or glow retardants has proven to be advantageous. A particular advantage of the aforementioned flame retardants or glow retardants is that they are natural and environmentally compatible materials, so that ecologically valuable and sustainable products can be obtainable.

The addition of oxidizing agents, in particular hydrogen peroxide, has been well proven in particular in the context of influencing or specifically setting the porosity of the foam material. Advantageously, the addition of an oxidizing agent, in particular hydrogen peroxide, also brings about a chemical modification, in particular of the fiber constituents, of the natural raw material used, from which ultimately a higher degree of crosslinking and a permanently stable crosslinking of the raw material contained in the foam material are achieved. Likewise, a stabilization of the foam structure and a uniform configuration of foam pores can be achieved, which in turn is advantageous for both the mechanical and physical properties of the foam material.

The bonding or crosslinking of the natural raw material or in particular of the corresponding fiber constituents can also be improved by using acrylates, urea, melamine, glyoxal and/or glyoxylic acid as additives, in particular already during the refining or milling process.

Furthermore, the foam structure of the foam material can be advantageously influenced by the addition of blowing agents. In particular, organic blowing agents in the form of azobisisobutyronitrile, azodicarbonamide, especially activated azodicarbonamide, dinitropentamethylenetetramine, hydrazodicarbonamide, oxybissulfohydrazide, oxybisbenzenesulfohydrazide, 5-phenyltetrazole, para-toluenesulfonylsemicarbazide, toluene/benzene sulfohydrazide and salts thereof, in particular alkali metal and alkaline earth metal salts. Likewise, inorganic blowing agents such as ammonium carbonate, sodium hydrogen carbonate, preferably in admixture with potassium hydrogen carbonate and an acid carrier, in particular disodium dihydrogen diphosphate, calcium dihydrogen phosphate or calcium citrate, and aluminum powder can be used in both acidic and basic environments.

Suitable thickeners and/or gelling agents include sulfite or sulfate pulp waste liquor, turpentine oil, gelling agents, alginates, flour or starch from cereals, potatoes, corn, peas or rice. Crosslinkers are preferably selected based on methyl cellulose or glutin.

Flour or starch from cereals, potatoes, corn, peas or rice can also be used as binding agents, as can proteins or lignosulfonate. Likewise, proteins can also be used as emulsifiers.

Furthermore, alums can be used advantageously as pH regulators, and synthetic additives, in particular isocyanates and polymers, in particular polyvinyl alcohol, polyethylene glycol and polyvinyl acetate, as plasticizers or structure modifiers.

Particularly good results are obtained in this context if the one or more additives have a proportion of less than 17 wt. %, in particular 12 wt. %, preferably 9 wt. %, preferably 7 wt. %, very preferably 6 wt. %, based on the total composition of the foam material.

It is even more preferably provided that the one or more additives has/have a proportion in the foam material in a range from 0 to 17 wt. %, in particular 0 to 12 wt. %, preferably 0.5 to 9 wt. %, preferably 1 to 7 wt. %, very particularly preferably 2 to 6 wt. %, based on the total composition of the foam material.

As far as the production of the foam layer of composite elements according to the invention on the basis of the foam material is concerned, this is advantageously based on an essentially inexpensive or uncomplicated method.

The starting point is the aforementioned, in particular highly viscous, fiber suspension, which can be obtained from the renewable raw material. Advantageously, the renewable raw material is subjected to at least one, preferably at least two refining processes or milling operations. From these, the, in particular highly viscous, fiber supersension is obtainable.

Depending on the intended application, one or more additives, in particular those mentioned above, can be added to the fiber suspension. Especially preferred is the addition of hydrogen peroxide, which positively influences the foam formation and also the compound of the fibers to a stable, solid foam.

Foam formation can be induced both physically and chemically, e.g. by foaming the fiber suspension by intensive stirring or by adding chemical blowing agents that release volatile components. Preferably, both variants can also be combined.

The, in particular foamed, fiber suspension based on renewable raw material and, if necessary, additives can subsequently be placed in a mold, which can vary depending on the geometry of the composite element to be produced. In this sense, rectangular and square molds are conceivable in particular, but prefabricated, customized molds can also be used for special applications. Preferably, the mold can be made of a renewable raw material or a material based on renewable raw materials, i.e., in particular, it can be made of or preferably consist of wood or wood-like fibers, waste paper, waste cardboard and/or fiber castings.

For the final production of the foam layer from the foam material in the form of the high-viscosity fiber supersension, it has been well proven if the high-viscosity fiber supersension is subjected to thermal treatment, for example in a temperature range between 100° C. to 200° C. During this thermal treatment, the liquid or solvent content, in particular the water content, is first removed from the fiber suspension. Likewise, chemical blowing agents can be activated and the foam material foamed or further foamed. Last but not least, the thermal treatment also achieves crosslinking of the fibers of the foam material, in particular by fiber constituents such as lignocellulose condensing and configuring a closely linked network.

Accordingly, it is therefore possible, in particular at least essentially, to dispense with the further addition of binding agents to the foam material or the fiber suspension, which has an overall positive effect on the sustainability aspect with respect to the composite element according to the invention.

After completion of the thermal treatment, a particularly strong, self-supporting and rigid foam in the form of a layer is thus finally obtained, in particular wherein the layer geometry corresponds to the shape used for the drying process.

According to the invention, it is thereby preferably provided that the foam layer is configured as a molded body, or in particular that the foam layer is a molded body.

According to a specific example, the foam material of the foam layer as well as the foam layer itself can thus be obtained as follows:

Wood fibers, in particular from beech or pine wood, for example, are converted in a first grinding process into a suspension, in particular a highly viscous suspension, for example with a solids content of 7%, and subsequently further defibered with the addition of water in an atmospheric refiner at room temperature. Subsequently, excess water is removed from the highly viscous wood fiber suspension via a screen and a solids content of 10 to 15% is set. Hydrogen peroxide (35% in water) is then added to the highly viscous suspension in amounts ranging from 5 to 35 wt. %, and the obtainable mass is stirred in an intensive mixer for a maximum of 4 minutes at room temperature. On the one hand, physical or mechanical foaming of the mass takes place, and on the other hand, chemical foaming and a modification of the fiber structure that positively influences the gas retention properties of the suspension are achieved. The obtained homogeneous, flowable mass is transferred into a mold, preferably perforated on all sides, and dried in an oven at 130° C. for a period in the range of 6 to 20 hours. The resulting foam material or the foam layer comprising the foam material comprise bulk densities in a range from 20 to 300 kg/m3 and bulk density-dependent compressive strengths in a range from 20 to 600 kPa at 10% compression.

For further details on the producing of foam materials as preferably used in the present invention, reference may also be made to EP 3 406 793 A1, the contents of which are hereby expressly referred to and the subject-matter of which is included in the present invention.

Turning now to the structure or nature as well as properties of the foam material, it is preferentially used in the context of the present invention if the foam material comprises an open-cell foam structure.

Furthermore, it is preferred if the foam material comprises a density of at most 300 kg/m3, in particular 275 kg/m3, preferably 250 kg/m3, and/or at least 20 kg/m3, in particular 40 kg/m3, preferably 50 kg/m3. Advantageously, therefore, the foam material comprises a density in a range from 20 to 300 kg/m3, in particular 40 to 275 kg/m3, preferably 50 to 250 kg/m3.

If the foam material is configured as a board for inter-rafter insulation, in particular as a clamping board, or is used in a board for inter-rafter insulation, the foam material preferably has a density of at most 80 kg/m3, in particular 60 kg/m3, preferably 50 kg/m3, and/or at least 20 kg/m3, in particular 30 kg/m3, preferably 40 kg/m3. Advantageously, the foam material according to this embodiment thus comprises a density in a range of 20 to 80 kg/m3, in particular 30 to 60 kg/m3, preferably 40 to 50 kg/m3. Due to the low densities and the associated lower compressive strengths, it is possible to fasten the panel, in particular the installation panel or clamping panel, by clamping between the rafters.

With regard to the strength of the foam layer, it has been well proven if the foam material comprises a compressive strength of at least 20 kPa and/or up to 600 kPa, in particular 400 kPa, preferably 250 kPa, at 10% compression. Advantageously then, the foam material comprises a compressive strength in a range from 20 to 600 kPa, in particular 30 to 400 kPa, preferably 40 to 250 kPa, at 10% compression.

Preferentially, it is provided in the context of the present invention that the foam layer is configured as an insulating layer, in particular as a thermal insulating layer and/or a sound insulating layer.

If the foam layer is configured as an insulating layer, in particular as a thermal insulation layer, it is preferred in the context of the present invention if the foam layer comprises a thermal conductivity in the range of 0.015 to 0.085 W/mK, in particular 0.018 to 0.07 W/mK, preferably 0.02 to 0.055 W/mK, preferably 0.021 to 0.045 W/mK. In this case, the thermal conductivity of the foam material is determined in accordance with DIN 4108-4-2020-11.

Now, with regard to the further nature of the composite element according to the invention or of the foam layer thereof, it can be provided within the scope of the present invention that the foam layer comprises, at least on one face, in particular surface, a three-dimensionally formed or embossed structure, in particular surface structure. In this sense, according to the composite element according to the present invention, at least one surface of the composite element may comprise a three-dimensionally formed or embossed structure, in particular surface structure

Preferentially, such a three-dimensionally formed or embossed structure is present in the form of depressions or elevations, in particular, for example, in the form of nubs. A composite element with a nub-like surface structure is suitable, for example, for use in the installation of underfloor heating systems as a so-called nubbed panel or mat, wherein the composite element in this case is preferably such that the heating pipes of the underfloor heating system can be clamped between the nubs.

In the event that the composite element comprises a nub-like structure on at least one face or, in particular, surface, it may be further preferred that the nubs are configured round or angular, in particular round or polygonal. Likewise, it may be provided that the arrangement of the nubs is configured regularly or irregularly, wherein a regular arrangement of the nubs, i.e. a uniformly or evenly dimensioned spacing of the nubs from one another, is preferential.

With regard to the nub itself, it may also be provided that the latter comprise further structural elements, such as, for example, a protruding or projecting or also overhanging configuration of the upper edge of the nub. For example, narrowed areas can be configured between the nubs, in particular in the area of the upper end of the nub. This can in turn be advantageous in the case of use of the composite element as a nubbed panel or mat for underfloor heating systems, since the heating pipes can thus be fixed between the nubs and are secured against slipping out or the like.

Alternatively or additionally, the heating pipes of an underfloor heating system can also be fixed to the composite element by means of stapler systems, in particular, for example, with stapler needles that enclose the pipes and thus fix or staple them to the composite element.

Likewise, it may be provided that the foam layer comprises recesses, in particular recesses suitable for accommodating pipes and lines, preferably floor heating systems.

Furthermore, a variant of a three-dimensionally configured or embossed structure can be configured in relation to the side surfaces or edges of the foam layer in the form of recesses and/or recesses, in particular, for example, in the form of plug-in connections, tongue-and-groove systems or puzzle systems.

Following on from this, it is also possible within the scope of the present invention, in accordance with this, for one of the edge surfaces or side surfaces of the composite element to comprise a three-dimensional surface structure which is designed or configured in particular in accordance with the intended use. For example, the edge faces can be configured in the form of plug-in connections, such as tongue-and-groove systems or puzzle systems, preferably jigsaw systems. Composite elements with edges designed as plug-in connections, tongue-and-groove systems and/or puzzle systems are particularly suitable for applications in which uncomplicated and time-efficient laying or connecting of the composite elements is desired. This may be the case, for example, for uses of the composite elements according to the invention as insulating elements or also as structural elements, in particular for interior fittings.

With regard to the further configuration of the composite element according to the invention, it may be provided in the context of a further preferred embodiment of the present invention that the composite element comprises at least one further layer in the form of a functional and/or reinforcing layer.

In this case, it has been well proven if the functional and/or reinforcing layer is arranged indirectly, in particular directly, to the foam layer, in particular is arranged on at least one surface of the foam layer, preferably on both surfaces of the foam layer.

Accordingly, in a more preferred embodiment of the present invention, it may thus be provided that the foam layer is arranged between two functional and/or reinforcing layers.

Advantageously, the functional and/or reinforcing layer is thereby configured as a functional film and/or reinforcing sheet.

In the event that the functional and/or reinforcing layer is configured as a functional foil, it has proved well-tested if the functional foil is configured as a sarking sheet, formwork sheet, vapor retarder, nonwoven layer or aluminum cover layer, in particular as a sarking sheet, nonwoven layer or aluminum cover layer.

In this sense, the foam layer can thus be laminated with a functional film configured as a functional and/or reinforcing layer, or the functional film can also be laminated onto the foam layer, or in particular also extruded onto it.

If an adhesion promoter layer is provided to further strengthen or improve the adhesion between the foam layer and the functional film, adhesion promoters or adhesives are preferably used, wherein it is well proven if these contain a plastic and/or a synthetic resin, preferably a polyurethane. Preferably, a polyurethane hot melt adhesive can be used within the scope of the invention.

If the composite element according to the invention comprises a functional film as a functional or reinforcing layer, the composite elements according to the invention are particularly advantageously suited for use in the insulation of roofs, in particular as above-rafter, between-rafter or below-rafter insulation. In particular, the composite elements according to the invention configured as described are characterized in an advantageous manner by the fact that they are easy to handle as prefabricated elements that can be laid directly and are uncomplicated to install.

According to an advantageous further development of the present invention, it can be provided for composite elements according to the invention, which comprise a functional film as a functional or reinforcing layer, that the functional film comprises at least one longitudinal edge-side adhesive zone on the upper side and/or the lower side. Longitudinal edge side means in particular an arrangement of the adhesive zone along an edge region or side edge of the functional film.

In this case, it is then preferably additionally provided that the functional film and foam layer are arranged in such a way that at least one region, in particular edge region, preferably a plurality of regions, in particular edge regions, results or result in which the film is not covered by the foam layer, so that the adhesive zone can be arranged in these. Accordingly, it is preferential in this sense if the foam layer comprises a smaller surface area than the functional film, relative to a central arrangement of foam layer and film relative to one another, so that free film edge areas result in which adhesive zones can be arranged.

These adhesive zones can be spaced from the longitudinal edge of the film and/or configured in the form of strips, possibly as interrupted strips, and can comprise a width of between 2 and 10 cm, for example. The installation of such adhesive zones can in particular significantly facilitate the laying of composite elements according to the invention, as well as enabling particularly durable and resistant bonding of the individual composite elements.

If the functional and/or reinforcing layer is configured as a reinforcing panel, it has proven advantageous for the composite element according to the present invention if the reinforcing panel is configured as a wood panel, chipboard, OSB panel, gypsum board, gypsum fiberboard, dry screed panel, concrete panel, plastic panel.

Equally, however, within the scope of a more preferably embodiment of the present invention, it can also be provided that the reinforcing panel configured as a functional and/or reinforcing layer is formed by a further foam layer as described above, i.e. the reinforcing panel can advantageously also be configured as a foam layer comprising a foam material comprising a natural, renewable raw material. In this case, the foam material preferably comprises the properties and special features already described above.

If the reinforcing panel is formed on the basis of a foam layer, it is further preferred if the foam material of the foam layer and the foam material of the reinforcing layer formed as a foam layer are different from each other, in particular, for example, with respect to the properties and/or compositions of the foam material and/or the foam layer obtained therefrom. In particular, the foam layer formed as a reinforcing sheet may comprise, for example, a higher compressive strength as well as a correspondingly higher density, while the actual foam layer comprises a lower density and likewise a lower thermal conductivity.

These different properties can advantageously be attributed to a different composition of the foam material, in particular, for example, to a different proportion of additives and/or to differences with respect to the particulate substrate, such as the raw material comprised therein and/or its composition. However, this likewise does not presuppose that the respective foam layers always differ unambiguously from one another optically or visually; rather, it may be that an optical or visual distinction between the foam layers is possible only on the basis of marginal deviations from one another

Furthermore, in the context of this embodiment of the present invention, it may be preferred if the foam layer is arranged between two functional and/or reinforcing layers formed as reinforcing panels. A corresponding composite element is thus characterized by a sandwich arrangement, which can be advantageous in particular in the field of interior fittings. For example, corresponding composite elements can be used as prefabricated components.

Composite elements according to the invention, which comprise a configuration as described above, are particularly advantageously suited for use in interior construction or in the thermal insulation of interior and exterior walls of buildings. Particularly advantageously, the composite elements according to the invention can be used here in the form of prefabricated components for installation, i.e., for example, as sarking panels or shuttering panels, and also as facade elements for exterior insulation or also as flat roof insulation panels, in or on the house. Likewise, use as a laying or clamping board for inter-rafter insulation is possible.

In an alternative preferred embodiment of the present invention, it may be provided that the reinforcing layer is configured in the form of a reinforcement. If the foam layer comprises a reinforcement, this is preferably configured in the form of a, in particular reinforcing, plate and/or panel, a, in particular supporting, woven and/or knitted fabric, a membrane and/or a foil.

Composite elements according to the invention, which comprise a foam layer and a reinforcement arranged thereon, are suitable in particular for use in composite thermal insulation systems. This aspect once again underscores the wide range of possible applications for composite elements according to the invention, which, depending on the requirements and specific configuration, can ultimately be used in all areas of the construction and finishing of buildings.

In the context of use as a composite thermal insulation system, the composite element according to the invention represents a particularly sustainable and thus positive alternative to conventional building materials. At the same time, the composite element according to the invention is characterized by such good mechanical and physical properties that, in particular with regard to the insulating performance of the composite element, no compromises need to be made compared with comparable products from the prior art.

As already mentioned in the context of the functional and/or reinforcing layer formed as a functional film, it is usually preferred in the context of the present invention if the foam layer and the at least one functional and/or reinforcing layer are firmly bonded, in particular materially bonded, with each other, preferably bonded with each other.

In this case, bonding of the foam layer and the at least one functional and/or reinforcing layer is possible both thermally, in particular in the case where the functional and/or reinforcing layer is configured as a functional film. Likewise, the use of adhesion promoters is well proven in the context of the present invention and is particularly preferred if the functional and/or reinforcing layer is configured as a reinforcing sheet. In particular, it may be provided in this context that an adhesion promoter layer is provided between the foam layer and the functional and/or reinforcing layer. Preferably, the adhesion promoter layer comprises an adhesion promoter or adhesive, wherein this comprises plastic and/or a synthetic resin, preferably a polyurethane. Preferably, a polyurethane hot melt adhesive may be used within the scope of the invention.

Furthermore, within the scope of the present invention, depending on the application or requirement for the composite element according to the invention, it may be advantageous if the foam layer and/or the functional and/or reinforcing layer are configured as a single layer or as multiple layers. Preferentially, the foam layer is configured as a multilayer.

A multilayer structure of the foam layer is to be understood in particular as meaning that the foam layer is composed of a plurality of layers, wherein the layers comprise different foam materials from layer to layer. Differences between the foam materials may exist, for example, with regard to the composition of the foam materials, e.g. with regard to the content of additives or also the nature and/or type of the natural raw material used. Likewise, the layers may comprise different mechanical or physical properties, i.e., for example, different foam density or strength.

In particular, by comprising foam layers that comprise a multilayer structure, composite elements according to the invention can be used to extend the range of properties and applications of the composite element. For example, a multi-layer structure of the foam layer lends itself to use of the composite element as a nubbed panel or mat or as an installation panel with recesses for underfloor heating. Specifically, in this case, the nubbed panel or the installation panel with recesses, the Footfall sound insulation located underneath and the underfloor heat insulation can be combined in a foam layer which comprises a corresponding multilayer structure, so that, on the basis of the composite element according to the invention, only one combination construction or construction element can be provided overall for the installation of an underfloor heating system.

Likewise, it is also possible to realize the aforementioned, usually three-part, floor structure consisting of underfloor heat insulation, footfall sound insulation and nubbed panel or installation panel with recesses in a composite element which is configured in a single layer, in particular according to the foam layer, i.e. in the form of a single-layer foam layer whose property profile meets all the aforementioned requirements or functions.

It is therefore possible, on the basis of the composite element according to the invention, to combine the three different functions of footfall sound insulation, thermal insulation and nubbed panel or installation panel with recesses, which are usually fulfilled by three different construction materials, in one product, i.e. the composite element according to the invention. In this way, a considerable material saving and in particular reduction of the plastic content in the floor structure can be achieved. Also, on the basis of the composite element according to the invention, the foam layer of which is configured as a nubbed sheet or installation panel with depressions, in particular a multilayer or single-layer nubbed sheet or installation panel with depressions, as described above, a considerable simplification of the installation work for a floor covering or the related substructure can be achieved, in particular if the functional and/or reinforcing layer of the composite element is configured, for example, as a reinforcing panel in the form of a dry screed panel or, for example, also in particular in the form of a further foam layer.

In particular, only one construction element is to be laid with the composite element according to the invention instead of usually at least three different construction materials. According to a preferred embodiment of the present invention, the composite element according to the invention in the form of a nubbed sheet and/or nubbed panel and/or installation panel with recesses thus replaces the Footfall sound insulation, thermally insulating, nubbed sheet or installation panel and the screed in a floor structure for an underfloor heating system, i.e. there is direct absorption of the top covering by the nubbed sheet and/or nubbed panel or installation panel with recesses. If the composite element is configured as an installation panel with recesses for an underfloor heating system, in particular as an underfloor heating element, it has been well proven if the installation panel comprises a heat-conducting layer, in particular a heat-conducting panel, on its upper side, in particular as the upper layer. The heat-conducting layer is preferably not provided in the recesses of the installation panel. The heat-conducting layer usually consists of a metal, in particular selected from the group of iron, copper and their alloys, preferably steel. In this connection, it may likewise be provided that the heat-conducting sheet comprises a coating, in particular a corrosion protection coating. When the installation panel is installed, in particular when the underfloor heating element is installed, the heat-conducting layer conducts the heat given off by the heating lines in the stiffeners over a large area to the floor covering so that the latter is heated evenly.

Furthermore, a multilayer structure of the foam layer can also be suitable if the foam layer is arranged between two functional and/or reinforcing layers designed as reinforcing panels. Sandwich arrangements of this kind, which are suitable in particular for composite elements in the form of prefabricated components, can comprise an advantageous property profile that is superior to that of conventional prefabricated components on the basis of a multilayer configuration of the foam layer, e.g. comprising a layer for thermal insulation and a further layer for sound insulation, by combining two different functions in an uncomplicated manner in one component.

A further subject-matter of the present invention—according to a second aspect of the present invention—is a use of a, in particular previously described, composite element for heat and/or sound insulation, in particular of buildings and/or roofs, preferably of floors, walls and roofs.

In particular, it has been well proven if the composite element, in particular as described above, is preferably in the form of insulation boards, preferably laminated above-rafter insulation boards, between-rafter insulation boards, in particular clamping boards below-rafter insulation boards, flat roof insulation boards, and/or facade elements, preferably below-deck boards, shuttering boards, and/or dry screed and/or prefabricated components and/or facing elements for interior finishing, is used for insulating and/or finishing the building envelope and/or roof, in particular for both exterior and interior applications.

For further details on this aspect of the invention, reference can be made to the preceding explanations on the composite element according to the invention, which apply accordingly with respect to the use according to the invention.

A further subject-matter of the present invention—according to a third aspect of the present invention—is a use of a composite element, in particular as described above, in the installation of heating and/or supply systems, in particular in floors and/or walls of buildings, preferably of floor heating systems.

In this context, it may be envisaged that the composite element replaces the footfall sound insulation and thermal insulation, preferably footfall sound insulation, thermal insulation and screed, in a floor structure. In this case, a direct mounting of the upper covering by the composite element according to the invention takes place.

For further details on this aspect of the invention, reference may be made to the preceding explanations on the composite element according to the invention as well as to the other aspects of the present invention, which apply accordingly with respect to the use according to the invention.

Again, a further subject-matter of the present invention—according to a fourth aspect of the present invention—is an underfloor heating element, in particular a nubbed sheet and/or nubbed mat and/or nubbed panel or an installation panel with recesses.

Here, it may be provided that the nubbed sheet and/or nubbed mat and/or nubbed panel or the installation panel replaces the footfall sound insulation, thermal insulation and nubbed sheet or installation panel with recesses, preferably footfall sound insulation, thermal insulation, nubbed sheet or installation panel with recesses and screed, in a floor structure for underfloor heating. In this case, the nubbed sheet and/or nubbed mat and/or nubbed panel or installation panel directly accommodates the top covering.

As previously explained, the underfloor heating element can be configured as an installation panel with recesses. In this case, the recesses are preferably configured as pipe or conduit guides for the lines of the underfloor heating systems. The recesses obtain a relief-like surface for the underfloor heating element in particular. The recesses can be comprised in the installation panel in any suitable manner, for example by shaping during producing or also subsequently, for example by milling. Usually, subsequent supply of the recesses is preferentially.

As has likewise been stated previously, if the underfloor heating element is configured as an installation panel with recesses, it comprises a heat-conducting layer, in particular a heat-conducting plate. Preferably, the heat-conducting layer is not provided in the recesses of the installation panel.

For further details on this aspect of the invention, reference may be made to the preceding explanations on the composite element according to the invention as well as to the other aspects of the present invention, which apply accordingly with respect to the nubbed sheet and/or nubbed mat and/or nubbed panel according to the invention.

Furthermore, subject-matter of the present invention—according to a fifth aspect of the present invention—is a thermal insulation, obtained from previously described composite elements, for use in thermally insulating walls and/or roofs.

Particularly preferred, in particular previously described, composite elements are suitable for use in on-roof insulation, inter-rafter insulation, under-roof insulation, façade insulation, floor insulation, and in particular also for use in composite thermal insulation systems.

For further details on this aspect of the invention, reference can be made to the preceding explanations on the composite element according to the invention as well as to the other aspects of the present invention, which apply accordingly with respect to the thermal insulation according to the invention.

A further subject-matter of the present invention—according to a sixth aspect of the present invention—is a footfall sound insulation and/or an acoustic absorber, obtainable from a previously described composite element, for use in the sound insulation of walls and/or floors of buildings.

For further details on this aspect of the invention, reference may be made to the preceding explanations on the composite element according to the invention as well as on the other aspects of the present invention, which apply accordingly with respect to the footfall sound insulation and/or acoustic absorber according to the invention.

Yet another subject-matter of the present invention—according to a seventh aspect of the present invention—is an in-situ foam for use as an insulating and/or construction material, in particular for thermal and/or acoustic insulation, comprising a foam material, wherein the foam material comprises a natural, renewable raw material.

In the context of this aspect of the present invention, it has been well proven if the foam material preferably provided for the foam layer of composite elements according to the invention is used for the in-situ foam, in particular in the form of a foamable and sprayable composition. In particular, it is understood here that with respect to the foam material for the in-situ foam, reference is made to a non-cured or still curable composition or mass, unless otherwise specified. In this sense, it is preferably provided that the foam material is configured in the form of a curable, freely moldable and/or freely distributable mass, in particular wherein the mass is further foamable and preferably applicable by spray application.

In particular, at least substantially, the composition of the local foam according to the invention thus corresponds to the composition of the foam material preferably used for foam layers of composite elements according to the invention in the uncured state. This means that the in-situ foam—analogous to the foam material of foam layers of composite elements according to the invention in the uncured state—is preferably present in the form of a fiber suspension, in particular a highly viscous fiber suspension. Advantageously, the foam material contains at least a small amount of a solvent. Preferably, the solvent is water.

With regard to the renewable raw material, it is preferably in accordance with the invention if the foam material comprises a natural, renewable raw material, as previously described in the context of the composite element according to the invention. In this context, reference should be made to the explanations regarding the composite element according to the invention.

Furthermore, it is preferably provided that the in-situ foam comprises one or more additives, in particular blowing agents. The blowing agents are preferably selected from organic blowing agents, in particular azobisisobutyronitrile, azodicarbonamide, preferably activated azodicarbonamide, dinitropentamethylenetetramine, hydrazodicarbonamide, oxybissulfohydrazide, oxybisbenzenesulfohydrazide, 5-phenyltetrazole, para-toluenesulfonylsemicarbazide, toluene/benzene sulfohydrazide and salts thereof, preferably alkali metal and alkaline earth metal salts. Likewise, inorganic blowing agents from the group of ammonium carbonate, sodium hydrogen carbonate, preferably in admixture with potassium hydrogen carbonate and an acid carrier, in particular disodium dihydrogen diphosphate, calcium dihydrogen phosphate or calcium citrate, and aluminum powder can be used. With regard to the blowing agent, the only decisive factor in particular is that the blowing agent causes expansion or foam formation at low temperatures, in particular at room temperature.

In this context, it is also advantageous to add oxidizing agents, preferably hydrogen peroxide, in particular as an additional blowing agent. The addition of hydrogen peroxide can advantageously permit selective setting of the porosity of the foam material

Furthermore, it has been well proven if the in-situ foam comprises a reactive crosslinker or a reactive binding agent. According to the invention, binding agents or crosslinking agents that crosslink quickly and completely during or immediately after application of the in-situ foam and cause the foam material or the in-situ foam to cure are preferred.

The reactive binding agent can be selected from silanes, polysilanes, silane hydrolysates, polysiloxanes, siliconates, titanates, polytitanates, zirconates, isocyanates, polyisocyanates, reactive polyurethanes and mixtures thereof, in particular silanes, polysilanes, silane hydrolysates, polysiloxanes, siliconates, polyisocyanates, reactive polyurethanes and mixtures thereof. In this sense, within the scope of the present invention, those reactive binding agents or crosslinking agents are preferably preferred in particular which crosslink independently of temperature influences and/or specifically in the presence of moisture, in particular in the form of atmospheric moisture and/or also liquid water.

Alternatively, reactive acrylates, in particular cyanoacrylates, have also proven to be suitable binding agents or crosslinkers in the context of the present invention.

Preferably, therefore, the foam material cures at room temperature and/or in the presence of moisture. Furthermore, it is preferred according to the invention if the foam material cures within a short time, in particular within a few minutes, preferably less than 15 minutes, preferably less than 10 min.

With regard to the formulation of the in-situ foam, this can vary depending on the application or the requirement for use. According to the invention, it is accordingly possible for the in-situ foam to be configured as a one-component or two-component formulation. In particular, a two-component formulation of the in-situ foam has proven to be suitable, in particular with regard to the preferred binding agents or crosslinking agents.

If the in-situ foam is configured as a two-component formulation, it has been well proven if the first component comprises the renewable raw material, in particular in the form of a fiber suspension, and one or more blowing agents. The second component preferably comprises the binding agent or the crosslinking agent. In the context of the application of the in-situ foam, the components are then preferably mixed immediately at the moment of application. In particular, it is provided here that the blowing agent preferably instantaneously causes foaming of the foam material and that the crosslinking agent immediately begins to crosslink and cure.

If the first component, in particular the fiber suspension comprised therein, comprises at least small amounts of a solvent, in particular water, the crosslinking or curing of the in-situ foam can additionally be positively influenced, in particular in the event that moisture-curing binding agents or crosslinking agents are contained in the in-situ foam.

In this way, a particularly stable and also advantageously porous foam can be obtained within the scope of the present invention on the basis of the in-situ foam according to the invention, which in terms of its nature and physical and mechanical properties advantageously corresponds to the foam material of the foam layer of composite elements according to the invention. The main advantage of the in-situ foam according to the invention is the flexible applicability of the foam and the possibility of effectively insulating even geometrically complex or difficult-to-access areas of a building envelope or roof.

For further details on this aspect of the invention, reference can be made to the preceding explanations on the composite element described above as well as to the other aspects of the present invention, which apply accordingly with respect to the in-situ foam according to the invention.

Furthermore, a subject-matter of the present invention—according to an eighth aspect of the present invention—is a particulate foam material in loose bulk, in particular for use as an insulating material, preferably in the form of a blow-in fill, for thermal and/or acoustic insulation, wherein the foam material comprises a natural, renewable raw material.

In the context of this aspect of the present invention, it has been well proven if for the particulate foam material the foam material preferably provided for foam layers of previously described composite elements is used, in particular in the form of a, in particular dry, pourable composition or mass. In this sense, it is preferably provided that the foam material of the foam layer described in context with the previously described composite element, in the cured, foamed state, is used present in the form of coarse particles.

These coarse particles can be obtainable, for example, by comminuting a foam layer or the cured foam material comprised therein. Likewise, cuttings or the like of the foam material can be used for the particulate foam material.

In this respect, the composition of the particulate foam material according to the invention corresponds in particular at least essentially to the composition of the foam material preferably used according to the invention for foam layers of composite elements described above.

Advantageously, the particulate foam material according to the invention—just like the composite element described above—is characterized by particularly good thermal and sound insulation properties. Accordingly, in a manner similar to the composite element described above, it is excellently suited for insulating, in particular thermally insulating and sound insulating, preferably thermally insulating, buildings and/or roofs, preferably floors, walls and roofs. Preferably, the particulate foam material is used as blow-in fill or blow-in insulation.

By being in the form of a preferably coarse-particulate loose fill, the particulate foam material is advantageously suitable for insulating areas of the building envelope or roof that comprise particularly demanding geometries and thus require flexible insulation solutions that can be inserted.

The particulate foam material preferably comprises a density in the range of 20 to 40 kg/m3, preferably 20 to 30 kg/m3

Due to the advantageously high or in particular exclusive proportion of renewable raw materials, the particulate foam material according to the invention furthermore represents a particularly sustainable and environmentally friendly alternative to conventional insulating agents

For further details on this aspect of the present invention, in particular on the foam material, reference can be made to the preceding explanations on the composite element described above and on the other aspects of the present invention, which apply accordingly with respect to the particulate foam material.

Finally, a subject-matter of the present invention—according to a ninth aspect of the present invention—is an installation panel, in particular for use in a floor structure or as an insulation panel for inter-rafter insulation, wherein the installation panel comprises a foam layer, and wherein the foam layer comprises a foam material, wherein the foam material comprises a natural, renewable raw material.

Installation panels according to the invention are advantageously characterized by a particularly high proportion of renewable raw material and, at the same time, exhibit mechanical and physical properties that comparable products from the prior art have not yet achieved. In particular with regard to compressive strength and dimensional stability, installation panels according to the invention stand out positively from prior art products.

In particular, installation panels according to the invention are suitable for use in a floor structure, in particular, for example, as a dry screed panel, as a floor insulation panel and/or as a substructure or underlay panel for a floor covering to be applied thereon. The installation panels are characterized by good compressive strength, in particular also under punctual compressive loads. In addition, the boards are particularly dimensionally stable, in particular also in the presence of, for example, moisture.

Advantageously, the installation panel comprising a foam layer can be configured as a molded body or, in particular, the installation panel is a molded body.

In a preferred embodiment of the installation panel according to the invention, the installation panel is the foam layer; i.e., the installation panel is formed from the foam layer or consists exclusively of the foam layer.

In this respect, it is even more preferably the case that the installation panel is configured in the form of a foam molded body or, in particular, that the installation panel is a foam molded body.

In accordance with the invention, the natural, renewable raw material is preferably a plant-based raw material, in particular based on lignified and/or woody plants, preferably wood. In this sense, the natural, renewable, in particular plant-based, raw material preferably comprises lignin- and/or lignocellulose-based raw materials or, in particular, plants.

Advantageously, almost all types of wood or components of woody plants, i.e. lignin- and/or lignocellulose-based plants, can be used in the context of the present invention. Accordingly, the natural, renewable, in particular plant-based, raw material may preferably be selected approximately from the group consisting of hardwood, softwood, bark, root material, thinning wood, woody annual plants and mixtures thereof. Likewise, it is also possible that the natural, renewable, in particular plant-based, raw material is obtainable from sawmill by-products, waste wood, wood-containing waste products and/or recyclable or recycled wood-containing products.

Advantageously, the natural, renewable, in particular plant-based, raw material comprises a particulate, in particular fibrous, shape and/or structure. Furthermore, it is preferably provided in the context of the present invention that the natural, renewable, in particular plant-based, raw material is in the form of particles, in particular fibers, preferably containing lignocellulose.

Depending on the intended application or use, it may be appropriate in the context of the present invention to modify the properties of the veneer sheet or the underlying foam layer and, consequently, of the foam material. In this context, it has been well proven if the foam material comprises one or more additives. Preferably, the one or more additives are selected from the group of hydrophobing agents, flame retardants, glow retardants, fungicides, oxidizing agents, blowing agents, thickening agents, crosslinking agents, gelling agents, emulsifiers, pH regulators, plasticizers, binding agents, inorganic and/or mineral fillers and/or mixtures thereof.

With regard to the mechanical or physical properties of the installation panel or the underlying foam layer and, accordingly, of the foam material, it is preferred if the foam material comprises a density of at most 300 kg/m3, in particular 275 kg/m3, preferably 250 kg/m3, and/or at least 20 kg/m3, in particular 40 kg/m3, preferably 50 kg/m3. Advantageously, then, the foam material comprises a density in a range from 20 to 300 kg/m3, in particular 40 to 275 kg/m3, preferably 50 to 250 kg/m3.

With regard to the strength of the installation panel or, in particular, of the foam layer, it has been well proven if the foam material comprises a compressive strength of at least 20 kPa and/or up to 600 kPa, in particular 400 kPa, preferably 250 kPa, at 10% compression. Advantageously, then, the foam material comprises a compressive strength in a range from 20 to 600 kPa, in particular 30 to 400 kPa, preferably 40 to 250 kPa, at 10% compression.

As far as the nature or configuration of the installation panel according to the invention is concerned, it is preferably provided that the installation panel or the underlying foam layer comprises, at least on one face, in particular surface, a three-dimensionally formed or embossed structure, in particular surface structure.

Preferably, such a three-dimensionally formed or embossed structure is present in the form of depressions or elevations, in particular in the form of nubs, channels or the like.

Another variant of three-dimensionally configured or embossed structures is configured in relation to the side surfaces or edges of the installation panel or, in particular, of the foam layer in the form of recesses and/or protrusions, in particular, for example, in the form of plug-in connections, tongue-and-groove systems or puzzle systems. Installation panels with edges formed as plug-in connections, tongue-and-groove systems and/or jigsaw systems are particularly suitable for applications in which uncomplicated and time-efficient installation or connection of the panels is desired, which is advantageous in particular for floor structures that are to be installed in a short time.

According to another preferred embodiment of the present invention, the installation panel may be configured as an underfloor heating element, in particular as a nubbed sheet and/or nubbed mat and/or nubbed panel or as an installation panel with recesses. In this case, the underfloor heating element is preferably configured only as a single layer, i.e. preferably comprises only one foam layer. If the underfloor heating element is configured as an installation panel with recesses, it may likewise be provided that the underfloor heating element comprises a further layer in the form of a heat-conducting layer. The heat-conducting layer is preferably a heat-conducting plate and has recesses in particular in the region of the recesses.

According to a further preferred embodiment, the installation panel is configured as a panel for inter-rafter insulation, in particular as a clamping panel. If the installation panel is configured as a panel for between-rafter insulation, the foam material preferably comprises a density of at most 80 kg/m3, in particular 60 kg/m3, preferably 50 kg/m3, and/or at least 20 kg/m3, in particular 30 kg/m3, preferably 40 kg/m3. Advantageously, the foam material according to this embodiment thus comprises a density in a range of 20 to 80 kg/m3, in particular 30 to 60 kg/m3, preferably 40 to 50 kg/m3. Due to the lower densities and, consequently, lower compressive strengths, it is possible to fix the installation panel by clamping it between the rafters.

For further details on this aspect of the invention, in particular on the foam layer or the foam material, reference can be made to the preceding explanations on the previously described composite element as well as on the other aspects of the present invention, which apply in accordance with the installation panel according to the invention.

Further advantages, properties, aspects and features of the present invention will be apparent from the following description of embodiments of the present invention which are preferred in accordance with the invention and which are shown in the drawings.

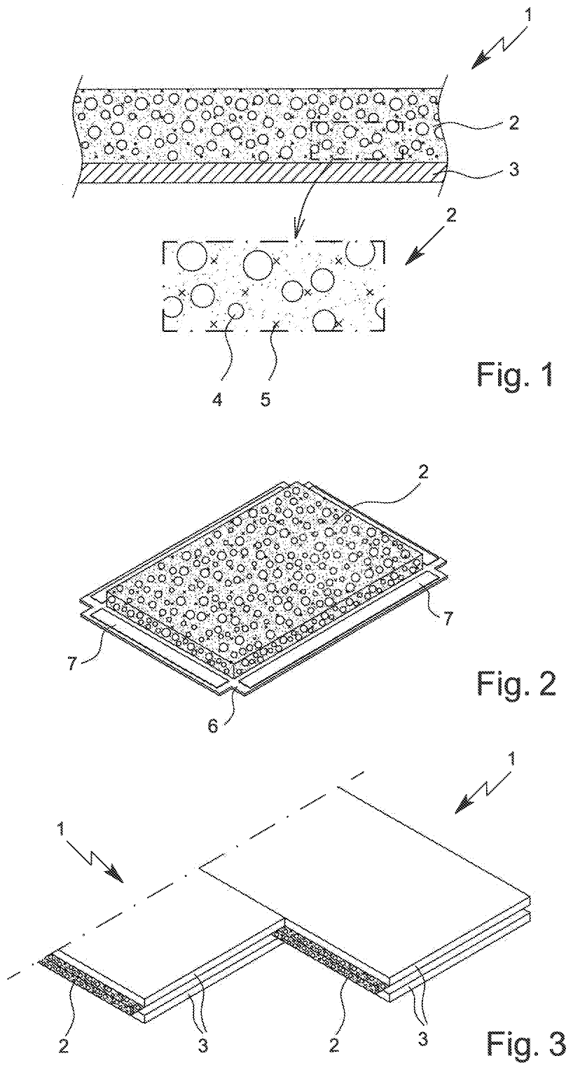

FIG. 1 shows a preferred configuration of a composite element 1 according to the invention, having a two-layer structure, wherein the composite element 1 comprises a foam layer 2. The foam layer 2 comprises a foam material containing a natural, renewable raw material 5.

According to the preferred configuration of the present invention reproduced in FIG. 1, the composite element 1 according to the invention further comprises a functional and/or reinforcing layer 3.

With regard to the foam layer 2, the latter is preferably obtainable on the basis of a natural, renewable raw material 5 in the form of a plant-based raw material, in particular on the basis of lignified and/or woody plants, preferably wood. Advantageously, almost all types of wood or components of woody plants can be used in the context of the present invention, such as, for example, hardwood, softwood, bark, root material, thinning wood, woody annual plants and mixtures thereof.

Likewise, according to a further advantage of the present invention, it is also possible that the renewable, in particular plant-based, raw material 5 is selected from sawmill by-products, waste wood, wood-containing waste products and/or recyclable or recycled wood-containing products. Thus, preferably, the natural, renewable, in particular plant-based, raw material 5 comprises lignin- and/or lignocellulose-based raw materials or, in particular, plants.

Preferably, the natural, renewable, in particular plant-based, raw material 5 is present in the foam material of the foam layer 2 in the form of particles, in particular fibers. In this context, it has proven well if the particles or, in particular, fibers of the natural, renewable raw material 5 comprise particle sizes and/or fiber lengths in a range from 100 μm to 50 mm, in particular 200 μm to 10 mm, preferably 250 μm to 5 mm, preferably 300 μm to 2.5 mm, based on the renewable raw material in its initial state.

Advantageously, the composite element 1 according to the invention is characterized by a high proportion of renewable raw material and thus represents a particularly sustainable configuration of a composite element. In this respect, the foam material of the foam layer 2 preferably comprises a proportion of the renewable raw material 5 of more than 84 wt. %, in particular 89 wt. %, preferably 92 wt. %, preferably 94 wt. %, very preferably 95 wt. %, based on the total composition of the foam material.

Depending on the intended application or use, it may further be provided in the context of the present invention that the foam layer 2 or the foam material comprised therein comprises one or more additives, wherein the one or more additives are preferably selected from the group consisting of hydrophobing agents, flame retardants, glow retardants, fungicides, oxidizing agents, blowing agents, thickening agents, crosslinking agents, gelling agents, pH regulators, plasticizers and/or mixtures thereof. In this respect, it has proven suitable if the one or more additives in the foam material of the foam layer 2 has or have a proportion of less than 17 wt. %, in particular 12 wt. %, preferably 9 wt. %, preferably 7 wt. %, very preferably 6 wt. %, based on the total composition of the foam material.

With regard to the structure of the foam layer 2, it is preferred for the composite element 1 according to the invention if the foam material of the foam layer 2 comprises an open-pored foam structure 4.

Advantageously, the foam material of the foam layer 2 achieves densities of less than 300 kg/m3, in particular less than 275 kg/m3, preferably less than 250 kg/m3, and/or more than 20 kg/m3, in particular more than 40 kg/m3, preferably more than 50 kg/m3. Furthermore, the foam layer 2 or the foam material comprised therein also achieves advantageous strengths, in particular of more than 20 kPa and/or up to 600 kPa, in particular 400 kPa, preferably 250 kPa, at 10% compression. Advantageously, the foam material thus comprises a compressive strength in a range of 20 to 600 kPa, in particular 30 to 400 kPa, preferably 40 to 250 kPa, at 10% compression.

In the context of a preferred configuration of the composite element 1 according to the invention, it is provided that the foam layer 2 is configured as an insulating layer, in particular as a thermal insulating layer and/or sound insulating layer.

In the form of an insulating layer, in particular a thermal insulating layer, the foam layer 2 can then comprise a thermal conductivity in a range from 0.015 to 0.085 W/mK, in particular 0.018 to 0.07 W/mK, preferably 0.02 to 0.055 W/mK, preferably 0.021 to 0.045 W/mK. Accordingly, the composite element according to the invention is suitable in particular for use as thermal as well as sound insulation, in particular for thermal insulation, of buildings and/or roofs, preferably of floors, walls and roofs.

With regard to the functional and/or reinforcing layer 3, it may be provided that this is configured as a functional foil 6 and/or as a reinforcing panel. If the functional and/or reinforcing layer is configured as a functional foil 6, it has been well proven in the context of the present invention if the functional foil 6 is configured as a sarking sheet, a formwork sheet, a vapor retarder, a nonwoven layer or an aluminum deck layer. It is more preferably the case that the functional film 6 is in the form of an underlayer, nonwoven layer or aluminum cover layer.

One such preferred configuration of the composite element 1 according to the invention can be seen in FIG. 2. Here, the composite element 1 according to the invention comprises a foam layer 2 as well as a functional film 6 designed as a functional and/or reinforcing layer.

In a preferred further development, the composite element 1 comprises at least one longitudinal edge-side adhesive zone 7 on the upper side and/or the underside of the film 6, in accordance with the configuration in FIG. 2, in particular on the side located at the bottom in the application, for example in the form of an insulating element, or on the side facing the roof.

The adhesive zones 7 are preferably spaced from the longitudinal edge of the film 6 and configured in strip form. By way of example, the adhesive zones 7 may comprise a width of between 2 and 10 cm.

Composite elements 1 which are represented as in FIG. 2 are suitable in particular for use in the insulation of roofs. Thereby, based on the advantageous configuration of the composite element 1, a particularly user-friendly or uncomplicated installation of the composite element 1 can be made possible, as well as in particular also a durable and resistant compound of individual composite elements 1 based on the adhesive zones 7 with each other can be achieved.

Within the scope of a further preferred configuration of the present invention, which is represented in FIG. 3, it may be provided that the functional and/or reinforcing layer is configured as a reinforcing plate. If the functional and/or reinforcing layer 3 is in the form of a reinforcing panel, it is preferred in the context of the present invention if the reinforcing panel is configured as a wood panel, particle board, OSB panel, gypsum board, gypsum fiber board, dry screed panel, concrete panel, plastic panel.

Furthermore, it can be provided for composite elements according to the invention that the foam layer 2 is arranged between two functional and/or reinforcing layers 3. Composite elements 1 with corresponding sandwich arrangements or configurations are particularly suitable for use as prefabricated components and can thus be used, for example, in particular in the interior finishing of buildings.

Further advantageously, it may be provided in the context of the present invention that composite elements 1 according to the invention comprise a three-dimensionally formed or embossed structure with respect to the side surfaces or edges of the foam layer 2 and/or of the composite element 1 as a whole. Exemplarily, these structures can be configured in the form of indentations and/or protrusions, in particular, for example, in the form of plug-in connections, tongue-and-groove systems or jigsaw systems, wherein the preferred composite element shown in FIG. 3 is equipped with a tongue-and-groove system.

As shown in FIG. 4, it can preferably be provided in the context of the present invention that the foam layer 2 comprises, at least on one surface, in particular surface, a three-dimensionally formed or impressed structure, in particular surface structure, in particular wherein such a structure can be present, for example, in the form of depressions or elevations, in particular, for example, in the form of nubs 9.

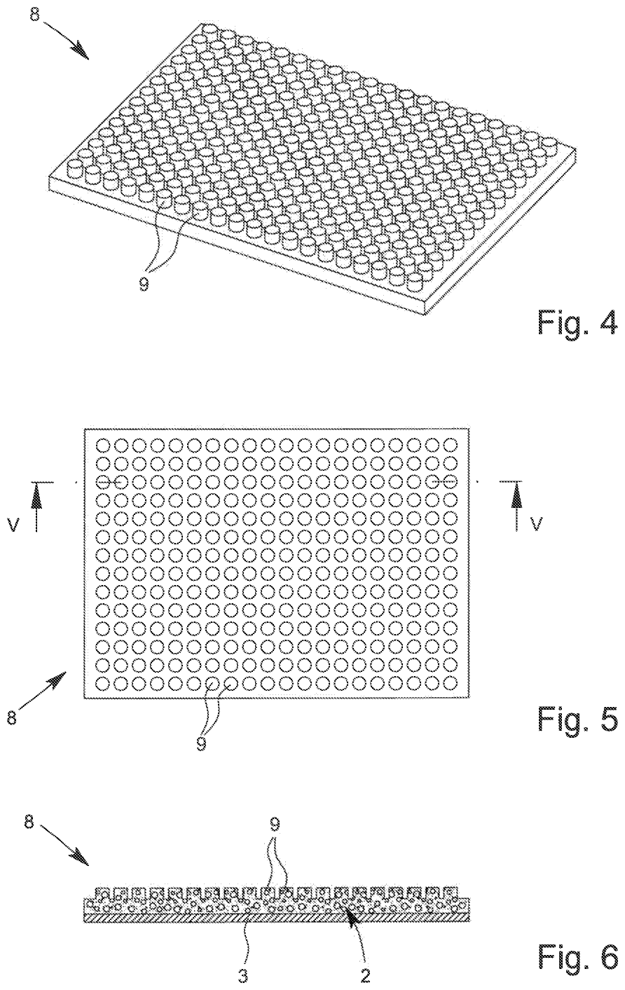

A composite element 1 of corresponding design in the form of a nubbed panel 8 can comprise, for example, round nubs 9. Furthermore, it has been well proven if the arrangement of the nubs 9 is configured regularly, i.e. there is a uniform or evenly dimensioned spacing of the nubs 9 from one another (see FIG. 4 and FIG. 5). FIG. 6 also shows a side view in the form of a schematic section through the nubbed panel 8, wherein the section runs along a line V-V, as shown in FIG. 5.

A composite element 1 according to the invention in the form of a nubbed panel 8, configured according to FIGS. 4 to 6, is suitable in particular for use for installing underfloor heating systems. In particular, the composite element 1 according to the invention in the form of the preferred configuration as a nubbed panel 8 is configured such that the heating pipes of an underfloor heating system can be arranged and laid between the nubs 9, wherein the heating pipes can likewise be fixed between the nubs 9. Alternatively or additionally, composite elements 1 according to the invention can also be combined with staple systems, in particular wherein the heating pipes of the underfloor heating system are fixed with staple pins. Preferably, the nubbed panel 8 is an underfloor heating element 11. In particular, the underfloor heating element 11 is configured such that it can be used as an installation panel for underfloor heating systems, wherein the pipes or lines of the underfloor heating system can preferably be arranged within the underfloor heating element 11 or can be accommodated by the same.

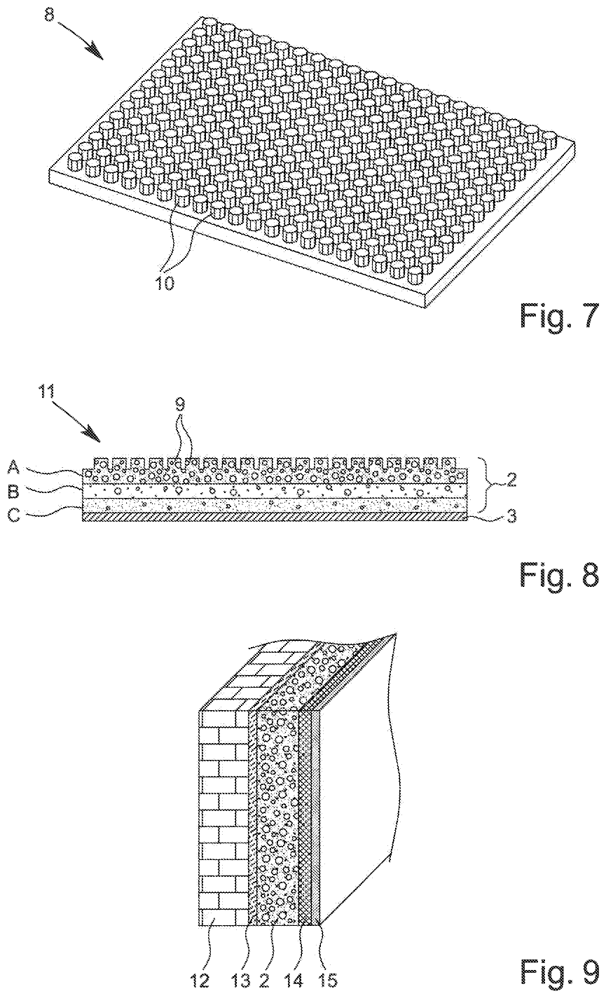

Alternatively to the configuration of the nubbed panel 8 according to FIGS. 4 to 6, it is also possible for the nubs to be configured to be angular, in particular polygonal. A corresponding nubbed panel 8 is shown in FIG. 7, in particular wherein the nubs 10 of the nubbed panel 8 are configured polygonal.

Furthermore, it can be provided within the scope of the present invention that the foam layer 2 and/or the functional and/or reinforcing layer 3 are configured in multiple layers, wherein preferably the foam layer 2 is configured in multiple layers. A composite element 1 configured according to this in the form of an underfloor heating element 11 is represented in FIG. 8.

According to this configuration of the present invention, the underfloor heating element 11 comprises a functional and/or reinforcing layer 3 and a three-layer foam layer 2. Here, the foam layer layer A is configured in the form of a nubbed panel or mat and comprises nubs 9 according to. The underlying foam layer B can in particular be configured as footfall sound insulation, and advantageously comprises a foam material that differs from the layer A. Here, there may be differences between the foam materials of layers A and B, for example, with regard to the composition of the foam material, i.e. the content of additives, or also the nature and/or type of the natural raw material used. Likewise, the foam materials of layers A and B may also comprise different mechanical and/or physical properties, i.e., for example, a foam density or strength that differs from each other. The same also applies to the foam layer C, which in the configuration of the composite element 1 according to the invention according to FIG. 8 is preferably configured as floor thermal insulation.

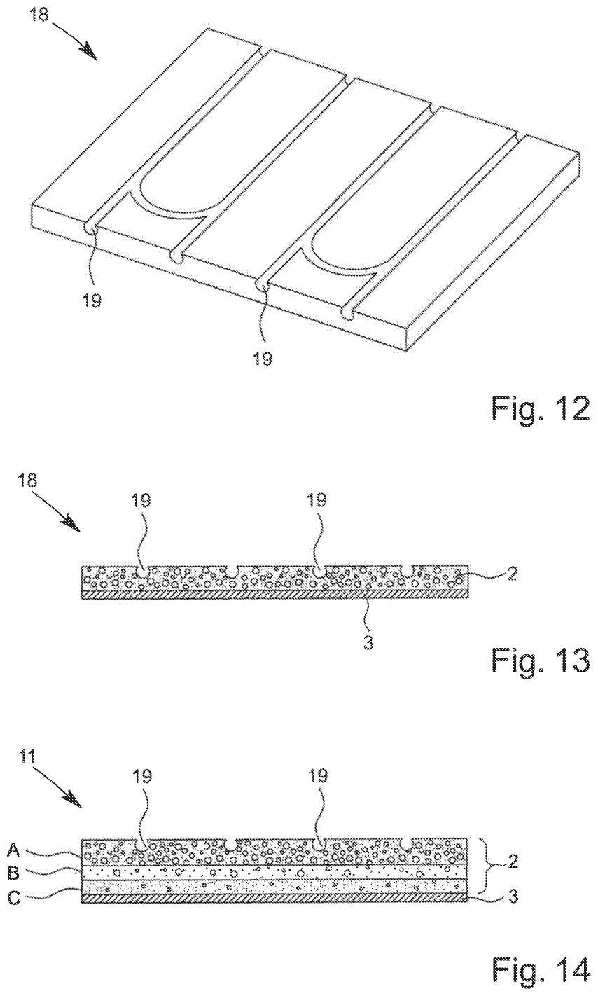

FIG. 12 shows an alternative representation of a composite system 1 according to the invention in the form of a laying panel. According to the embodiment shown in the figure, the installation panel 18 comprises recesses 19 which are suitable in particular for accommodating pipes and lines, for example of underfloor heating systems. The recesses 19 obtain a relief-like surface for the installation panel 18 in particular. The depressions 19 can be produced in particular by shaping during the producing of the installation panel 18 or by processing the installation panel 18 after its producing, for example by milling. Preferably, the depressions 19 are arranged on the installation panel 18 in such a way that pipes or conduits can be laid over a plurality of installation panels 18 arranged in a row and/or connected with each other.

In addition to one or more foam layers 2, the installation panel 18 may also comprise one or more functional or reinforcing layers 3. According to the embodiment shown in FIG. 13, the installation panel 18 comprises a foam layer 2 and a functional or reinforcing layer 3.

According to a preferred embodiment, the installation panel 18, in particular the installation panel 18 with recesses 19, is configured as an underfloor heating element 11. The underfloor heating element 11 may comprise, in addition to one or more foam layers 2, one or more functional or reinforcing layers 3. In particular, it may be provided in the context of the present invention that the foam layer 2 and/or the functional and/or reinforcing layer 3 are configured in multiple layers, wherein preferably the foam layer 2 is configured in multiple layers. A composite element 1 configured according to this in the form of an underfloor heating element 11 is represented in FIG. 14.

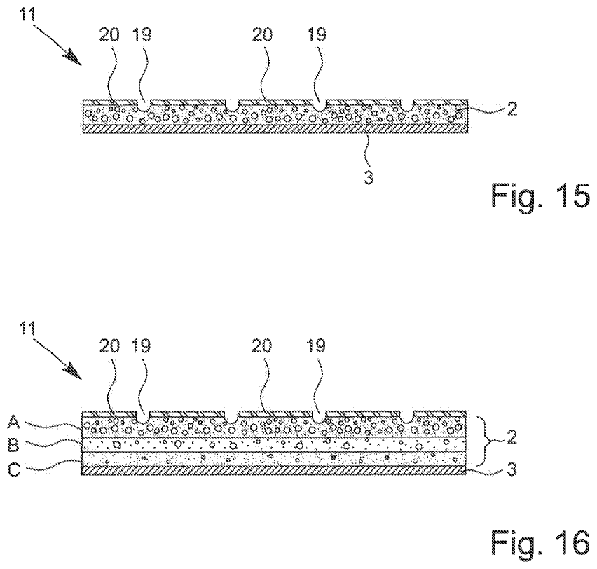

According to a further preferred embodiment of the invention, the underfloor heating element 11 comprises a heat-conducting layer 20 in the form of an installation panel 18 with recesses 19. Corresponding composite elements 1 are represented in the representations according to FIGS. 15 and 16. FIG. 15 shows a composite system 1 designed as an underfloor heating element 11 in the form of an installation panel 18 with recesses 19. A further layer, namely a heat-conducting layer 20, is applied to the foam layer 2. The thermally conductive layer 20 is preferably a thermally conductive sheet and consists in particular of a metal, preferably selected from the group consisting of iron, copper and alloys thereof. In this context, it is preferred if the heat-conducting layer 20, in particular the heat-conducting sheet, is made of steel. The heat conducting sheet may in turn be coated, for example with a corrosion protection coating. Preferably, the thermally conductive layer 20 is applied to the foam layer 2 over the entire surface, in particular using adhesive, wherein the thermally conductive layer 20 preferably comprises recesses in the region of the recesses 19 and in the region of fastening sections, such as tongue-and-groove systems.

FIG. 16 shows a further embodiment of the underfloor heating element 11 in the form of an installation panel 18 with recesses 19. According to FIG. 16, the foam layer 2 comprises a multilayer structure with the layer sequence A-B-C, as previously described. The embodiment shown in FIG. 16 likewise comprises a thermally conductive layer 20.

On the basis of the composite element 1 according to the invention, it is thus possible to provide novel insulation and construction elements which, compared to conventional insulation or floor structures, are both more sustainable and material-saving, and can be installed in a more user-friendly manner.

In the context of a further preferred configuration of the composite element 1 according to the invention, it may be provided that the reinforcing layer is configured in the form of a reinforcement 14, in particular wherein the foam layer 2 is then arranged directly adjacent to the reinforcement 14. Exemplary reinforcements 14 may in particular be configured in the form of a, preferably reinforcing, panel and/or panel, a, preferably supporting, woven and/or knitted fabric, a membrane and/or a foil.

Composite elements 1 configured according to this are advantageously suitable for use in composite thermal insulation systems, as shown in FIG. 9. An exemplary composite thermal insulation system, as represented in FIG. 9, further comprises, in addition to the composite element 1 according to the invention, in particular an adhesive layer 13 and a plaster 15 applied to the reinforcement 14 of the composite element. Via the adhesive layer 13, the composite element 1 is thereby preferably connected to the wall 12 to be insulated via the foam layer 2.

Thus, on the basis of the composite element 1 according to the invention, a large number of applications can be provided for the construction sector, in particular for the construction and/or extension of buildings, which can fulfill a wide variety of purposes. In particular, composite elements 1 according to the invention are suitable for use as insulating materials, in particular for heat and/or sound insulation, wherein the predominant applications of composite elements according to the invention are likewise accompanied by a significantly easier, more user-friendly and more efficient installation of the composite element according to the invention in comparison with comparable prefabricated construction elements of the prior art.

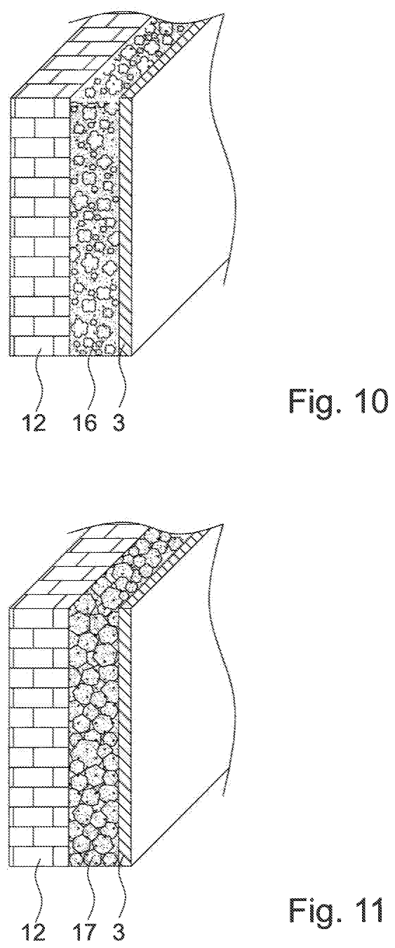

In addition to the composite element 1 according to the invention, which is decisively characterized by the foam layer 2 included therein, in particular also with regard to the mechanical or physical properties of the composite element 1, the use of an in-situ foam 16 in the field of insulation, in particular thermally insulating and/or footfall sound insulation, of buildings and/or roofs may also be provided within the scope of the present invention. A corresponding application of an in-situ foam 16 can be seen in FIG. 10, according to which the in-situ foam 16 is arranged between a wall 12 and a functional and/or reinforcing layer 3, in this case in particular in the form of a pre-wall construction based on a reinforcing plate, in particular wherein the in-situ foam 16 is particularly suitable for application to geometrically demanding detailed formations.

In this connection, it has been well proven within the scope of the present invention if the foam material preferably provided for the foam layer 2 of composite elements 1 according to the invention is used for the in-situ foam 16 according to the invention, in particular in the form of a foamable and sprayable composition. Advantageously, the composition of the in-situ foam 16 according to the invention thus corresponds at least substantially to a composition of the foam material preferably used for foam layers 2 of composite elements 1 according to the invention, in particular in the uncured or cured state.

In addition to the renewable raw material 5 contained in the foam material of the in-situ foam 16, the in-situ foam 16 may further comprise one or more additives, in particular blowing agents, and preferably a reactive crosslinking agent or a reactive binding agent. Based on this composition, both uniform foaming and rapid curing of the in-situ foam 16 can be achieved.

The composition or formulation of the in-situ foam, for example in the form of a one-component or two-component formulation, is preferably selected in such a way that the in-situ foam or the foaming agent contained therein, preferably comprising a renewable raw material, a blowing agent and a reactive crosslinking agent or a reactive binding agent, foams or expands during application or immediately thereafter and also begins to crosslink and cure.

Since the in-situ foam 16 is preferably in the form of a sprayable and free-forming foam material, the foam is particularly suitable for insulating geometrically demanding or difficult-to-access areas. The foam material may be present in particular in the form of the highly viscous fiber suspension, which is also used to produce the foam layers 2 of composite elements 1 according to the invention as starting material for the.

Finally, another aspect of the present invention is a particulate foam material as shown in FIG. 11. Here, the particulate foam material 17 has been filled between a wall 12 and a functional and/or reinforcing layer, in particular in the form of a pre-wall structure based on a reinforcing plate in this case.

In this respect, it is preferred in the context of the present invention if the particulate foam material 17 is in the form of a pourable composition or mass, in particular a dry composition, wherein this preferably substantially corresponds to the composition of foam material included in foam layers 2 of composite elements 1 according to the invention. In particular, the particulate foam material 17 can be obtainable from the, in particular cured, foam material of the foam layers 2, if this is, for example, comminuted in the course of a further manufacturing step or, however, is obtained in the form of, for example, cut scraps.

### REFERENCE SIGNS

1 Composite element
2 Foam layer
3 Functional and/or reinforcing layer
4 Open-pored foam structure
5 Renewable raw material
6 Functional film
7 Adhesive zones
8 Nubbed panel
9 Round nub
10 Angular nub
11 Underfloor heating element
12 Wall
13 Adhesive layer
14 Reinforcement
15 Plaster
16 In-situ foam
17 Particulate foam material
18 Installation panel
19 Recess
20 Thermally conductive layer
A Foam layer layer A
B Foam layer layer B
C Foam layer layer C

1. A composite element for insulating and/or construction, the composite element comprising an at least two-layer structure, wherein at least one layer of the at least two-layer structure of the composite element comprises a foam layer, wherein the foam layer comprises a foam material, and wherein
the foam material comprises a natural, renewable raw material.

2. The composite element according to claim 1 wherein the natural, renewable raw material is a plant-based raw material based on lignified and/or woody plants.

3. The composite element according claim 1, wherein the natural, renewable raw material has a proportion of the foam material of more than 84 wt. %, based on the total composition of the foam material.

4. The composite element according to claim 1, wherein the foam material comprises one or more additives selected from the group of hydrophobing agents, flame retardants, glow retardants, fungicides, oxidizing agents, blowing agents, thickening agents, crosslinking agents, gelling agents, emulsifiers, pH regulators, plasticizers, binders and/or a mixture thereof.

5. The composite element according to claim 1, wherein the foam material comprises a density of less than 300 kg/m³.

6. The composite element according to claim 1, wherein the foam layer is configured as a thermal insulating layer and/or sound insulating layer.

7. The composite element according to claim 1, wherein the foam layer comprises a thermal conductivity in a range from 0.015 to 0.085 W/mK.

8. The composite element according to claim 1, wherein the foam layer comprises, at least on one surface, a three-dimensionally formed or embossed surface structure.

9. The composite element according to claim 1, wherein the composite element comprises at least one further layer in the form of a functional and/or reinforcing layer.

10. The composite element according to claim 9, wherein the functional and/or reinforcing layer is configured as a functional film and/or reinforcing sheet.

11. The composite element according to claim 10, wherein the functional foil is configured as one of a sarking sheet, a formwork sheet, a vapor barrier, a nonwoven layer and a aluminum cover layer.

12. The composite element according to claim 11, wherein the reinforcing panel is configured as one of a wood panel, chipboard, OSB panel, gypsum board, gypsum fiberboard, dry screed panel, concrete panel, and a plastic panel.

13. A method of using the composite element according to claim 1 for thermal and/or acoustic insulation in buildings and/or roofs.

14. A method of using the composite element according to claim 1 in the installation of heating and/or supply systems in floors and/or walls of buildings.

15. An underfloor heating element obtainable from the composite element according to claim 1, the underfloor heating element being configured for the installation of heating and/or supply systems in underfloor heating systems.

16. A thermal insulation obtained from the composite element according to claim 1, the thermal insulation being configured for thermally insulating walls and/or roofs of buildings.

17. A footfall sound insulation and/or acoustic absorber, obtainable from the composite element according to claim 1, wherein the footfall sound insulation and/or acoustic absorber is configured for use in the sound insulation of walls and/or floors of buildings.

18. An in-situ foam for insulating and/or construction, the in-situ foam comprising a foam material, wherein the foam material comprises a natural, renewable raw material.

19. A particulate foam material in loose bulk configured for use as insulation, wherein
the foam material comprises a natural, renewable raw material.

20. An installation panel configured for use in a floor structure or as an insulating panel for inter-rafter insulation, wherein the installation panel comprises a foam layer, and wherein the foam layer comprises a foam material, wherein the foam material comprises a natural, renewable raw material.

21. The installation panel according to claim 20, wherein the installation panel is configured as an underfloor heating element, the underfloor heating element being a nubbed sheet and/or a nubbed mat and/or a nubbed panel or an installation panel with recesses.

22. The installation panel according to claim 20, wherein the installation panel is configured as a clamping panel for inter-rafter insulation.

23. The composite element according to claim 1, wherein the natural, renewable raw material has a proportion of the foam material of more than 84 wt. %, based on the total composition of the foam material, and wherein the raw material is present in the form of fibers containing lignocellulose.
